(19) United States
(12) Patent Application Publication
(10) Pub. No.: US 2026/0039130 A1
(43) Pub. Date: Feb. 5, 2026

(54) SHOPPING CART SYSTEM

(71) Applicant: TOSHIBA TEC KABUSHIKI KAISHA, Tokyo (JP)

(72) Inventor: Yuki Suzuki, Numazu Shizuoka (JP)

(21) Appl. No.: 19/176,231

(22) Filed: Apr. 11, 2025

(30) Foreign Application Priority Data
Aug. 2, 2024 (JP) 2024-126641

(51) Int. Cl. H02J 7/00; B62B 3/14; G06Q 20/20

(52) U.S. Cl. CPC H02J 7/0036; B62B 3/1424; B62B 3/1428; G06Q 20/208; H02J 7/0013; H02J 7/0047; H02J 7/00712

(57) ABSTRACT

A shopping cart system includes a shopping cart that includes an input connector that receives a charging current and a DC voltage of a DC power supply different from a supply power supply of the charging current, a first resistor connected in parallel to an input line of the DC voltage, and a first output connector that outputs, to an input connector of another cart connected to a subsequent stage of the cart, the DC voltage across the first resistor and a part of the charging current received by the input connector. The power supply device includes a second output connector that outputs a charging current and a DC voltage via a second resistor connected in series to an output line of the DC power supply, and an energization control unit that stops the charging current when a voltage across the second resistor exceeds a predetermined value.

### CROSS-REFERENCE TO RELATED APPLICATION

This application is based upon and claims the benefit of priority from Japanese Patent Application No. 2024-126641, filed on Aug. 2, 2024, the entire contents of which are incorporated herein by reference.

### FIELD

Embodiments described herein relate generally to a shopping cart system.

### BACKGROUND

In the related art, there is proposed a shopping cart in which a commodity registration device is mounted on the shopping cart, and a customer can register a commodity to be purchased by the customer while shopping in a store. Such a shopping cart is moved to a predetermined position and a battery for operating a commodity registration device is charged.

In such a shopping cart, a battery included in the shopping cart can be charged in a state in which a plurality of shopping carts are stacked. Therefore, each shopping cart is implemented to be connected by an electrical contact. Although a current from the power supply device is supplied to an upstream contact, when the number of connected shopping carts increases, the current supplied from the power supply device may exceed a rated current. When the power supply device is continuously used in a state in which the current exceeding the rated current is supplied in this way, there is a concern that durability of the power supply device may be impaired.

### DESCRIPTION OF THE DRAWINGS

FIG. 1 is an external view showing an example of a shopping cart system according to an embodiment.

FIG. 2 is a first perspective view of the shopping cart.

FIG. 3 is a second perspective view of the shopping cart.

FIG. 4 is a perspective view showing an example of a power supply device.

FIG. 5 is a hardware block diagram showing an example of a hardware configuration of the shopping cart system.

FIG. 6 is a first diagram showing an example of a main configuration of an output connector provided in the power supply device and the shopping cart.

FIG. 7 is a second diagram showing an example of the main configuration of the output connector.

FIG. 8 is a first diagram showing a main configuration of an input connector provided in the shopping cart.

FIG. 9 is a second diagram showing an example of the main configuration of the input connector.

FIG. 10 is a block diagram showing an example of a functional configuration of an energization control circuit.

FIG. 11 is a diagram showing a method for estimating the number of connected shopping carts by the shopping cart system.

### DETAILED DESCRIPTION

An aspect is to provide a shopping cart system capable of ensuring durability of a power supply device that supplies a charging current to a shopping cart.

In general, according to one embodiment, the shopping cart system includes a plurality of shopping carts each including a terminal device configured to register a commodity to be purchased, and a power supply device configured to supply a charging current to the terminal device.

Each of the shopping carts includes an input connector configured to receive, from the power supply device or a previous stage shopping cart, a charging current of a battery of the terminal device and a DC voltage of a DC power supply included in the power supply device and different from a power supply that supplies the charging current, a first resistor connected in parallel to an input line of the DC voltage, and a first output connector configured to output the DC voltage across the first resistor and a part of the charging current received by the input connector to the input connector of another shopping cart connected to a subsequent stage of the shopping cart. The power supply device includes a second output connector configured to output the charging current and the DC voltage via a second resistor connected in series to the output line of the DC power supply to the input connector of the shopping cart, a voltage measurement unit configured to measure a voltage across the second resistor, and an energization control unit configured to stop the charging current when the voltage measured by the voltage measurement unit exceeds a predetermined value.

Hereinafter, an embodiment will be described in detail with reference to the drawings. The disclosure is not limited to the embodiment to be described later.

Hereinafter, a shopping cart 10 according to an embodiment of the present disclosure will be described with reference to the drawings.

### Schematic Configuration of Shopping Cart System

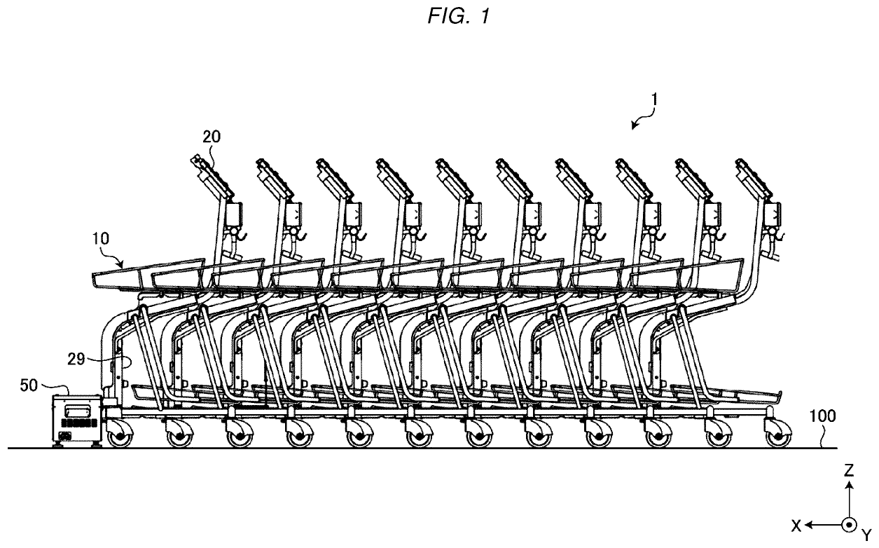

A schematic configuration of a shopping cart system 1 according to an embodiment will be described with reference to FIG. 1. FIG. 1 is an external view showing an example of a shopping cart system according to an embodiment.

The shopping cart system 1 includes a power supply device 50 and a plurality of shopping carts 10.

The power supply device 50 supplies, to the shopping carts 10 connected thereto, a current for charging batteries 29 that drive cart terminals 20 included in the shopping carts 10. The power supply device 50 is, for example, an AC adapter or an AC/DC converter. The power supply device 50 converts a commercial AC voltage of 100 V into a predetermined DC voltage Ea (for example, +24 V) and supplies the DC voltage Ea to the shopping cart 10 connected to the power supply device 50.

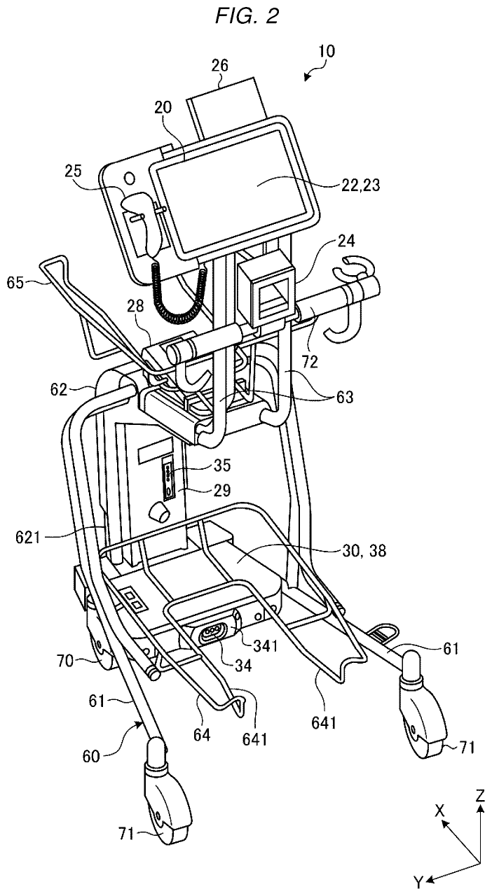

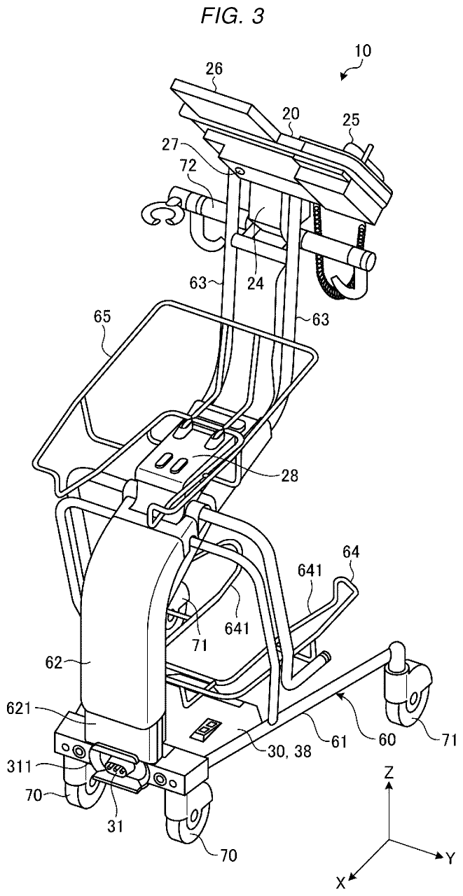

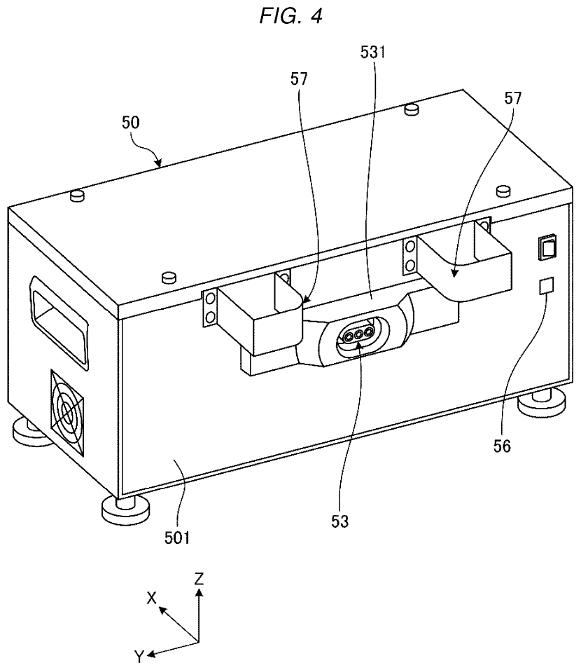

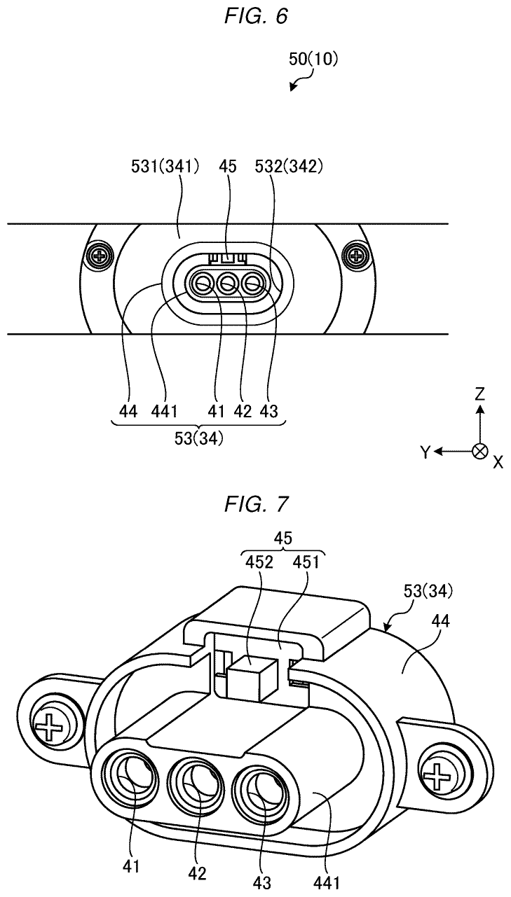

The battery 29 included in the shopping cart 10 is charged by a current supplied from the power supply device 50. Specifically, an output connector 53 (see FIG. 4) of the power supply device 50 is connected to an input connector 31 (see FIG. 3) of the shopping cart 10 to supply a current for charging to the shopping cart 10. In the plurality of shopping carts 10, in a stacked state shown in FIG. 1, an output connector 34 (see FIG. 2) included in a previous stage shopping cart 10 and the input connector 31 (see FIG. 3) included in a subsequent stage shopping cart 10, which are closer to the power supply device 50, are connected to each other, so that the current for charging is supplied to the subsequent stage shopping cart 10. In terms of an electric circuit, the batteries 29 of the shopping carts 10 are connected in parallel when viewed from the power supply device 50. Structures of the input connector 31 and the output connectors 53, 34 will be described in detail later (see FIGS. 6 to 9).

The number of connectable shopping carts 10 is determined by, for example, a current value that can be output by the power supply device 50, a charging current of the battery 29, a consumption current of the cart terminal 20, and consumption currents of various connection devices. For example, when the rated current that can be output by the power supply device 50 is 10 A and the charging current necessary for charging the battery 29 is 1 A, excluding a consumption current by a wiring or the like, the number of shopping carts 10 that can be charged simultaneously will be 10. However, when the charging of the batteries 29 of several shopping carts 10 among the connected 10 shopping carts 10 is already completed, the charging current is not supplied to the shopping cart 10 for which the charging is completed, and thus the 11-th and subsequent shopping carts 10 can also be charged. That is, an upper limit value of the number of the shopping carts 10 being charged among the shopping carts 10 connected to the power supply device 50 is 10.

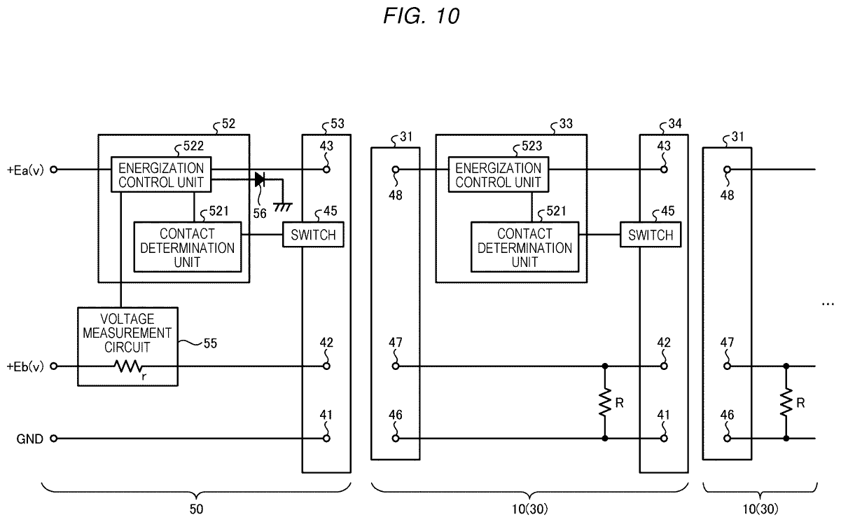

In general, the power supply device 50, more specifically, an AC adapter, an AC/DC converter, or the like included in the power supply device 50 can output a current exceeding a rated value. For example, a power supply device having a rated current of 10 A can output a maximum current of about 12 A. However, if the current is continuously used in a state in which the rated current is exceeded, durability of the power supply device 50 may be impaired, and thus it is recommended to use the power supply device in an area below the rated current. Therefore, in the shopping cart system 1 according to the present embodiment, the power supply device 50 has a function of stopping the supply of the charging current when more than a predetermined number of shopping carts 10 are stacked. Details will be described later (see FIG. 10).

### Schematic Configuration of Shopping Cart

A schematic configuration of the shopping cart 10 will be described with reference to FIGS. 2 and 3. FIG. 2 is a first perspective view of the shopping cart. FIG. 3 is a second perspective view of the shopping cart.

While a customer is pushing the shopping cart 10 in a store, the shopping cart 10 reads commodity information of a commodity that the customer wants to purchase and registers the commodity. The customer accommodates the registered commodity in a shopping basket or the like placed on the shopping cart 10 and continues shopping. After the shopping is finished, the customer goes to a checkout machine (not shown) and causes the checkout machine to perform settlement processing related to the registered commodity. The shopping cart 10 itself may have a function of performing settlement processing.

In the present description, for convenience, an XYZ coordinate system including an X axis, a Y axis, and a Z axis is defined. The XYZ coordinate system is provided for the shopping cart 10. The X axis, the Y axis, and the Z axis are orthogonal to one another. The X axis is provided along a front-rear direction of the shopping cart 10. The Y axis is provided along a width direction (a left-right direction) of the shopping cart 10. The Z axis is provided along a height direction (an up-down direction) of the shopping cart 10.

Further, in the present description, an X direction, a Y direction, and a Z direction are defined. The X direction is a direction along the X axis and includes a +X direction indicated by an arrow of the X axis and a −X direction opposite to the arrow of the X axis. The Y direction is a direction along the Y axis and includes a +Y direction indicated by an arrow of the Y axis and a −Y direction opposite to the arrow of the Y axis. The Z direction is a direction along the Z axis and includes a +Z direction indicated by an arrow of the Z axis and a −Z direction opposite to the arrow of the Z axis. The +Z direction is the same as an upward vertical direction, and the −Z direction is the same as a downward vertical direction.

The shopping cart 10 includes a frame 60, a pair of front wheels 70 (see FIG. 3), and a pair of rear wheels 71. The frame 60 includes a pair of left and right bottom frames 61, a lower frame 62, and an upper frame 63. The pair of left and right bottom frames 61, the lower frame 62, and the upper frame 63 are coupled to each other. An interval between the pair of front wheels 70 is narrower than an interval between the pair of rear wheels 71. The front wheels 70 and the rear wheels 71 are installed in a state of being separated from each other in the front-rear direction (X direction) of the shopping cart 10. The front wheel 70 and the rear wheel 71 are attached to the bottom frame 61 by attachment members (not shown). The directions of the front wheels 70 and the rear wheels 71 can be changed to the left and right with an attachment position to the bottom frame 61 as an axis. Therefore, a traveling direction of the shopping cart 10 can be changed to the left and right in response to a force applied to a handle 72 installed above the shopping cart 10. That is, the shopping cart 10 is turnable. The customer grips the handle 72 and pushes the shopping cart 10 while turning the shopping cart to the left and right.

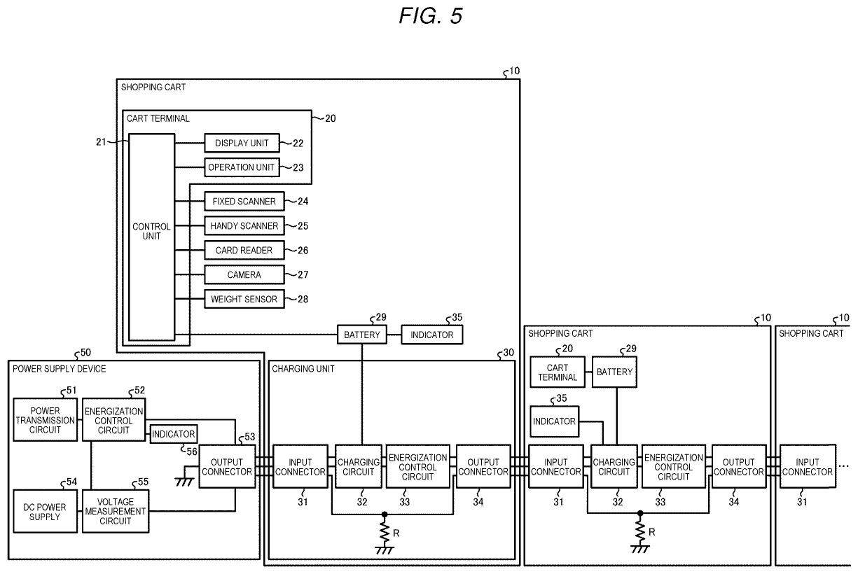

A charging unit 30 is attached between the pair of left and right bottom frames 61. The charging unit 30 incorporates a charging circuit 32 (see FIG. 5), and the battery 29 is charged by the charging circuit 32. The charging unit 30 includes the input connector 31 (see FIG. 3) and the output connector 34. The charging unit 30 also serves as a strength member that connects the left and right bottom frames 61.

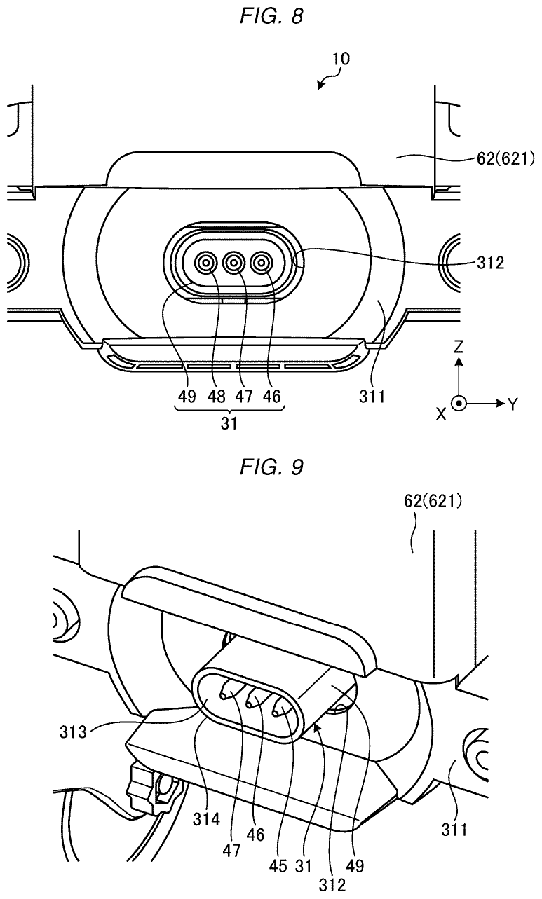

The input connector 31 is a charging connector connected to the output connector 53 (see FIG. 4) of the power supply device 50. A current for charging the battery 29 for operating the cart terminal 20 is supplied from the power supply device 50 to the input connector 31. A DC voltage signal for determining the number of connected shopping carts 10 is supplied from the power supply device 50 to the input connector 31. Further, the input connector 31 includes a ground line that transmits a ground (GND) level, which is a reference potential, from the power supply device 50. That is, the input connector 31 transmits three types of signals. The input connector 31 is also a charging connector connected to the output connector 34 of the previous stage shopping cart 10. The current for charging the battery 29 included in the shopping cart 10 is supplied to the input connector 31 from the output connector 34 of the previous stage shopping cart 10. The DC voltage signal for determining the number of shopping carts 10 connected to the power supply device 50 is supplied to the input connector 31 from the output connector 34 of the previous stage shopping cart 10. Further, the input connector 31 includes a ground line that transmits a ground (GND) level, which is a reference potential, from the output connector 34 of the previous stage shopping cart 10. The input connector 31 is attached to a housing 38 of the charging unit 30 with an outside of the input connector 31 covered with an input connector cover 311. The input connector 31, the output connector 34, and the output connector 53 of the power supply device 50 are all installed at positions with a same height from a floor surface. A detailed structure of the input connector 31 will be described later (see FIGS. 8 and 9).

The output connector 34 is a charging connector connected to the input connector 31 of the subsequent stage shopping cart 10. The output connector 34 transfers a part of the current for charging the battery 29 supplied to the previous stage shopping cart 10 to the subsequent stage shopping cart 10. The output connector 34 supplies a DC voltage signal for determining the number of shopping carts 10 connected to the power supply device 50, which is supplied from the previous stage shopping cart 10, to the subsequent stage shopping cart 10. Further, the output connector 34 includes a ground line that transmits a ground (GND) level, which is a reference potential, from the previous stage shopping cart 10. The output connector 34 is attached to the housing 38 of the charging unit 30 with the outside of the output connector 34 covered with an output connector cover 341. A detailed structure of the output connector 34 will be described later (see FIGS. 6 and 7). The output connector 34 is an example of a first output connector in the present disclosure.

The lower frame 62 is attached to a front side (+X direction) of the bottom frame 61, rising upward (+Z direction) and then extending obliquely upward toward the front (−X direction). The lower frame 62 holds the battery 29. The battery 29 is a rechargeable secondary battery that supplies a current to various electronic devices included in the shopping cart 10. The battery 29 is, for example, a lithium-ion battery, a nickel-cadmium battery, a nickel-hydrogen battery, or a lead storage battery.

The battery 29 includes an indicator 35. The indicator 35 is formed of a light-emitting member such as an LED, and indicates a charging state of the battery 29 by the charging circuit 32 (see FIG. 5). The indicator 35 indicates, for example, that the battery 29 is in a fully charged state, that the battery 29 is being charged, and that the charging is stopped by achieving, for example, a turn-off state, a turn-on state, or a blinking state. The indicator 35 may include a plurality of LEDs, and each state may be indicated by the number of LEDs that are turned on or a combination of the LEDs that are turned on. In addition, the indicator 35 may include a plurality of LEDs having different emission colors, and each state may be indicated by the different colors of the LEDs to be turned on.

A pair of upper frames 63 are attached to an upper end of the lower frame 62 facing upward (+Z direction). The rod-shaped handle 72 along the left-right direction (Y direction) of the shopping cart 10 is attached to the pair of upper frames 63. Various electronic devices included in the shopping cart 10 are attached to the upper frame 63 and the handle 72.

A lower basket receiving frame 64 is attached to the bottom frame 61 and the lower frame 62. A shopping basket (not shown) is placed on the lower basket receiving frame 64 in which a customer accommodates commodities when shopping. The lower basket receiving frame 64 has a pair of left and right guide surfaces 641. The pair of guide surfaces 641 come into contact with a guided portion 621 provided below the lower frame 62 of the subsequent stage shopping cart 10 that enters between the pair of guide surfaces 641, thereby guiding (directing) the subsequent stage shopping cart 10 so that the input connector 31 of the subsequent stage shopping cart 10 moves toward its own output connector 34.

An upper basket receiving frame 65 is attached to the upper frame 63. A shopping basket (not shown) is placed on the upper basket receiving frame 65 in which a customer accommodates commodities when shopping.

A weight sensor 28 is installed on the upper frame 63 at a position extending to the front side (−X direction). The weight sensor 28 is positioned below the upper basket receiving frame 65 and measures a weight of a commodity put in a shopping basket placed on the upper basket receiving frame 65.

The cart terminal 20, a hand scanner 25, a card reader 26, and a camera 27 (see FIG. 3) are installed on an upper portion of the upper frame 63. A fixed scanner 24 is installed on the handle 72. These electronic devices operate with the power of the battery 29.

The cart terminal 20 registers a commodity purchased by a customer. The cart terminal 20 includes a display unit 22 and an operation unit 23. The cart terminal 20 may further have a function of performing settlement related to the registered commodity. The cart terminal 20 is an example of a terminal device in the present disclosure.

The display unit 22 displays various types of information related to the registration of the commodity. The display unit 22 is, for example, a liquid crystal monitor or an organic EL monitor.

The operation unit 23 detects operations on various buttons displayed on the display unit 22. The operation unit 23 is, for example, a touch panel stacked on the display unit 22.

The fixed scanner 24 reads a code symbol such as a barcode attached to a commodity to be sold that is held up to a reading window on a front surface. A commodity code for uniquely identifying a commodity is registered in the code symbol. The fixed scanner 24 acquires the commodity code by decoding a reading result of the code symbol.

Similarly to the fixed scanner 24, the hand scanner 25 reads the code symbol attached to the commodity and acquires the commodity code. In particular, the hand scanner 25 is used to read a code symbol of a commodity whose code symbol is difficult to read by the fixed scanner 24, such as a heavy load or a large commodity.

The card reader 26 reads information registered in an IC card or a magnetic card possessed by the customer. The card reader 26 may read information stored in an electronic chip of an inserted IC card, or may read information stored in a magnetic stripe by scanning. The card reader 26 may read information stored in a card by performing short-range wireless communication.

The card reader 26 reads, for example, member information registered in a member card of a customer. Based on the member information read by the card reader 26, the cart terminal 20 may display, for example, bargain information or service information of a commodity matching the preference of the customer on the display unit 22 with reference to a purchase history of the customer. When the shopping cart 10 further has a function of performing the settlement processing, the card reader 26 may read registration information of a credit card used by the customer for payment, a charge amount of an electronic money card, a prepaid card, or the like.

The camera 27 captures an image of an area including the shopping basket placed on the upper basket receiving frame 65. The cart terminal 20 transmits identification information for identifying itself, the image captured by the camera 27, a weight of the shopping basket measured by the weight sensor 28, and commodity registration information at that time to a store server (not shown) in association with each other.

The store server analyzes the information transmitted from the shopping cart 10 and monitors whether an unregistered commodity is put into the shopping basket. Specifically, in a case in which the weight of the shopping basket increases even though the commodity is not registered, it is determined that there is a possibility that the customer puts the unregistered commodity into the shopping basket. In such a case, the store server transmits a signal for calling attention to the cart terminal 20. Then, the cart terminal 20 displays a message for calling attention on the display unit 22. The cart terminal 20 may output a warning sound from a speaker (not shown). Further, the store server may notify a mobile terminal carried by a store clerk of the store of an identification number of the corresponding shopping cart 10. The clerk who receives the notification goes to the corresponding shopping cart 10 and checks the commodity registration information and the commodity put in the shopping basket. Such monitoring processing may be performed by the cart terminal 20 itself.

Although only the camera 27 and the weight sensor 28 for monitoring the shopping basket placed on the upper basket receiving frame 65 are shown in FIGS. 2 and 3, the camera and the weight sensor may also be installed on the lower basket receiving frame 64 side to monitor the shopping basket placed on the lower basket receiving frame 64.

### Schematic Configuration of Power Supply Device

A schematic configuration of the power supply device 50 will be described with reference to FIG. 4. FIG. 4 is a perspective view showing an example of the power supply device.

The power supply device 50 includes a housing 501, the output connector 53, an output connector cover 531, and guide portions 57. The power supply device 50 is installed (fixed) on, for example, a floor surface 100 (see FIG. 1) of the store.

The housing 501 is formed in a rectangular parallelepiped shape. A power transmission circuit 51, an energization control circuit 52, a DC power supply 54, a voltage measurement circuit 55, and an indicator 56 shown in FIG. 5 are accommodated in the housing 501. The function of each unit will be described in detail later.

The guide portions 57 are a pair of convex portions provided along the Y axis with the output connector 53 interposed therebetween. The pair of guide portions 57 are installed at an interval slightly larger than a width of the guided portion 621 (see FIG. 3) of the shopping cart 10. The guided portion 621 of the shopping cart 10 is guided between the pair of guide portions 57 to facilitate connection between the input connector 31 of the shopping cart 10 and the output connector 53 of the power supply device 50.

### Hardware Configuration of Shopping Cart System

A hardware configuration of the shopping cart system 1 will be described with reference to FIG. 5. FIG. 5 is a hardware block diagram showing an example of the hardware configuration of the shopping cart system according to the embodiment.

The power supply device 50 included in the shopping cart system 1 accommodates the power transmission circuit 51, the energization control circuit 52, the output connector 53, the DC power supply 54, the voltage measurement circuit 55, and the indicator 56 inside the housing 501.

The power transmission circuit 51 is a power source that supplies a current necessary for charging the battery 29. The power transmission circuit 51 includes, for example, an inverter circuit that converts a commercial AC voltage of 100 V into a DC voltage, and a rectifier circuit that rectifies an output of the inverter circuit and converts the output into the DC voltage Ea (for example, +24 V).

The energization control circuit 52 supplies a charging current to the shopping cart 10 connected to the output connector 53 when the shopping cart 10 is connected to the output connector 53 and the number of connected shopping carts 10 is less than a predetermined value. The energization control circuit 52 stops the supply of the charging current when the number of connected shopping carts 10 is equal to or greater than a predetermined value. The function of the energization control circuit 52 will be described in detail later (see FIG. 10).

The output connector 53 has the same size and shape as the output connector 34 (see FIG. 2) of the shopping cart 10. The output connector 53 is attached to the housing 501 of the power supply device 50 in a state in which the outside is covered with the output connector cover 531. A detailed structure of the output connector 53 will be described later (see FIGS. 6 and 7). The output connector 53 is an example of a second output connector in the present disclosure. The DC power supply 54 is a voltage source that supplies a DC voltage Eb (for example, +5 V) for determining the number of shopping carts 10 connected to the power supply device 50. The DC power supply 54 is generated, for example, by dividing the DC voltage Ea generated by the power transmission circuit 51.

The voltage measurement circuit 55 is a circuit that measures a voltage across a resistor r connected in series to an output line of the DC voltage Eb. An operation of the voltage measurement circuit 55 will be described in detail later (see FIG. 10). The voltage measurement circuit 55 is an example of a voltage measurement unit in the present disclosure. The resistor r is an example of a second resistor in the present disclosure.

The indicator 56 is formed of a light-emitting member such as an LED, for example, and is turned on when the energization control circuit 52 supplies the charging current, and is turned off when the energization control circuit 52 does not supply the charging current. The indicator 56 is an example of a notification unit in the present disclosure.

The shopping cart 10 included in the shopping cart system 1 includes the cart terminal 20, the charging unit 30, the battery 29, the fixed scanner 24 which is a peripheral device, the hand scanner 25, the card reader 26, the camera 27, and the weight sensor 28.

The cart terminal 20 performs various types of processing related to commodity registration. The cart terminal 20 includes a control unit 21, the display unit 22, and the operation unit 23.

The control unit 21 controls various types of processing related to the commodity registration performed by the cart terminal 20 itself. The control unit 21 controls operations of various peripheral devices connected thereto. The control unit 21 includes a CPU, a RAM, a ROM, and a storage unit. The CPU loads a control program stored in the storage unit into the RAM and executes a control program to cause the cart terminal 20 to perform predetermined processing related to registration of a commodity or the like. The functions of the display unit 22 and the operation unit 23 included in the cart terminal 20 are as described above.

The functions of the fixed scanner 24, the hand scanner 25, the card reader 26, the camera 27, and the weight sensor 28, which are peripheral devices connected to the control unit 21, are as described above. The functions of the battery 29 and the indicator 35 are as described above.

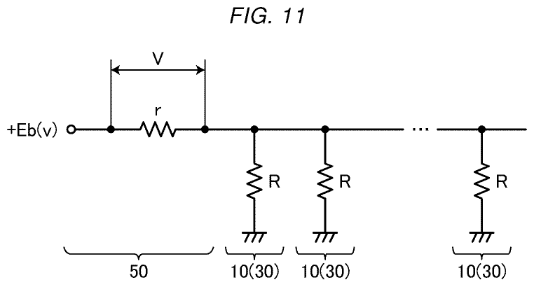

The charging unit 30 charges the battery 29. The charging unit 30 includes the input connector 31, the charging circuit 32, an energization control circuit 33, and the output connector 34. A resistor R is connected in parallel between the input connector 31 and the output connector 34. The function of the resistor R will be described in detail later (see FIGS. 10 and 11).

The charging unit 30 is fixed to the frame 60 in a state of being accommodated in the housing 38 (see FIGS. 2 and 3). The input connector 31 and the output connector 34 are supported by the housing 38 and exposed to the outside of the housing 38.

The input connector 31 is connected to the output connector 53 of the power supply device 50 to input a current (voltage signal) from the power supply device 50. The input connector 31 is connected to the output connector 34 included in the charging unit 30 of the previous stage shopping cart 10 to input an electric signal from the previous stage shopping cart 10. The electric signal is transmitted through three signal lines of a signal line that supplies a charging current, a signal line that supplies a voltage for determining the number of connected shopping carts 10, and a ground line that transmits a ground (GND) level. That is, the input connector 31 includes three terminals. In the present embodiment, the input connector 31 is constituted by a plug.

The output connector 34 is connected to the input connector 31 included in the charging unit 30 of the subsequent stage shopping cart 10 to output an electric signal to the subsequent stage shopping cart 10. Three signal lines including a signal line for supplying a charging current, a signal line for supplying a voltage for determining the number of connected shopping carts 10, and a ground line for transmitting a ground (GND) level are connected to the output connector 34. In the present embodiment, the output connector 34 includes a socket.

The charging circuit 32 supplies a part of the current from the power supply device 50 to the battery 29 that operates the cart terminal 20 for charging.

The energization control circuit 33 supplies a current to the subsequent stage shopping cart 10 only when the shopping cart 10 is connected to the subsequent stage of the energization control circuit. On the other hand, when the shopping cart 10 is not connected to the subsequent stage of the energization control circuit, the energization control circuit 33 does not output a current from the output connector 34. Accordingly, even when the output connector 34 is carelessly touched with a hand, there is no risk of electric shock.

### Structure of Output Connector

The structures of the output connector 53 and the output connector 34 will be described with reference to FIGS. 6 and 7. FIG. 6 is a diagram showing a main configuration of an output connector included in the power supply device and the shopping cart. FIG. 7 is a perspective view showing a detailed structure of an output connector included in the power supply device and the shopping cart. Since the output connector 53 included in the power supply device 50 and the output connector 34 included in the shopping cart 10 have the same structure, the output connector 53 included in the power supply device 50 will be described here as an example.

The output connector 53 is installed on the housing 501 of the power supply device 50 (see FIG. 4) so as to face the −X direction. The output connector 53 includes a socket 41, a socket 42, a socket 43, and a socket housing 44.

The socket 43 is formed of a conductive member and outputs the DC voltage Ea (for example, +24 V) from the power supply device 50. The socket 43 is also referred to as a female terminal.

The socket 42 is formed of a conductive member, and outputs a DC voltage from the DC power supply 54 via the voltage measurement circuit 55. The socket 42 is also referred to as the female terminal.

The socket 41 is formed of a conductive member and is a ground (GND) terminal of the power supply device 50. The socket 41 is also referred to as the female terminal.

The socket housing 44 is molded to surround outer peripheries of the socket 41, the socket 42, and the socket 43, and supports the socket 41, the socket 42, and the socket 43 in parallel at a predetermined interval. That is, the socket housing 44 includes an outer peripheral surface 441 surrounding the outer peripheries of the socket 41, the socket 42, and the socket 43. The socket housing 44 is also referred to as a shell. The arrangement of the socket 41, the socket 42, and the socket 43 is not limited to the examples of FIGS. 6 and 7.

A switch 45 is embedded in a base of the outer peripheral surface 441 of the socket housing 44. The switch 45 includes a switch housing 451 and a switch button 452.

The switch housing 451 protects an internal structure of the switch 45 and supports the switch button 452.

The switch button 452 is supported by an elastic member such as a spring so as to be able to reciprocate along an extending direction (+X direction, −X direction) of the socket 41, 42, and 43 with respect to the switch housing 451. When the input connector 31 is inserted into the output connector 53, the switch button 452 is pushed in the +X direction by a tip portion 314 (see FIG. 9) of a plug housing 49 of the input connector 31 to be described later. The switch 45 performs a momentary operation that is turned on when the switch button 452 is pressed by a predetermined amount and is turned off when a pressing amount is less than the predetermined amount. The energization control circuit 52 of the power supply device 50 outputs a voltage signal from the output connector 53 when the switch 45 is turned on, and stops outputting the voltage signal when the switch 45 is turned off. That is, the switch 45 functions as a so-called interlock switch.

The output connector cover 531 is attached to the outside of the socket housing 44. The output connector cover 531 has an opening 532 that exposes the outer peripheral surface 441 of the socket housing 44 to the outside. The opening 532 is formed in a size that does not allow a finger to reach the switch button 452 even when the finger is inserted from the outside. Accordingly, a voltage signal is prevented from being output from the output connector 53 due to inadvertent contact with the switch button 452.

In the present embodiment, an example in which the switch 45 is implemented by a push switch is shown, and the form of the switch 45 is not limited thereto. For example, the switch 45 may be a photosensor including a pair of a light-emitting element and a light-receiving element. The switch 45 may include a magnetic sensor or a capacitance sensor.

The output connector 34 of the shopping cart 10 has the same structure as the output connector 53. That is, the output connector 34 is installed in the shopping cart 10 in a state in which the outer peripheral surface 441 of the socket housing 44 is exposed to the outside from an opening 342 formed in the output connector cover 341. Further, when the input connector 31 of the subsequent stage shopping cart 10 is connected, the switch 45 included in the output connector 34 outputs a voltage signal from the output connector 34 to the input connector 31 of the subsequent stage shopping cart 10.

### Structure of Input Connector

The structure of the input connector 31 included in the shopping cart 10 will be described with reference to FIGS. 8 and 9. FIG. 8 is a first diagram showing a main configuration of the input connector included in the shopping cart. FIG. 9 is a second diagram showing an example of the main configuration of the input connector.

The input connector 31 is installed on an X-axis positive side of the charging unit 30, that is, on the front side of the shopping cart 10, facing forward with respect to the shopping cart 10. The input connector 31 includes a plug 46, a plug 47, a plug 48, and the plug housing 49.

The plug 48 is formed of a conductive member and is removably connected to the socket 43. The plug 48 receives a voltage signal (for example, +24 V) from the socket 43. The plug 48 is also referred to as a male terminal. A part of the voltage signal received by the plug 48 is supplied to the battery 29 from the charging unit 30 in which the plug 48 is installed.

The plug 47 is formed of a conductive member and is removably connected to the socket 42. The plug 47 receives a DC voltage from the DC power supply 54. The plug 47 is also referred to as a male terminal.

The plug 46 is formed of a conductive member and is removably connected to the socket 41. The plug 46 makes its own potential equal to a potential (ground potential) of the socket 41. The plug 46 is also referred to as a male terminal. The arrangement of the plug 46, the plug 47, and the plug 48 is not limited to the examples of FIGS. 8 and 9. That is, the plug 46, the plug 47, and the plug 48 are arranged to be removably connected in the above-described combination in accordance with the arrangement of the socket 41, the socket 42, and the socket 43 included in the output connector 53 (34).

The plug housing 49 is formed to surround the plug 46, the plug 47, and the plug 48 with gaps between the plug housing 49 and the plug 46, between the plug housing 49 and the plug 47, and between the plug housing 49 and the plug 48, and supports the plug 46, the plug 47, and the plug 48 in parallel at the same intervals as the socket 41, the socket 42, and the socket 43. The plug housing 49 includes an elongated cylindrical inner peripheral surface 313, a depth of the inner peripheral surface 313 is made deeper than the length of the plugs 46, 47, and 48, and the tip portion 314 is formed at a tip of the inner peripheral surface 313.

The plug housing 49 is fixed to the charging unit 30 by screwing or the like.

The input connector cover 311 is attached to the outside of the plug housing 49. The input connector cover 311 has an opening 312 through which the plugs 46, 47, and 48 and the plug housing 49 for protecting the plugs 46, 47, and 48 penetrate.

When the input connector 31 is connected to the output connector 53 or the output connector 34, the inner peripheral surface 313 of the plug housing 49 is inserted along the outer peripheral surface 441 of the socket housing 44, whereby the plug 46 and the socket 41 are connected, the plug 47 and the socket 42 are connected, and the plug 48 and the socket 43 are connected.

In the present embodiment, the input connector 31 includes the plug 46, 47, and 48 and the output connector 34 and 53 include the socket 41, 42, and 43, and the embodiment is not limited thereto. For example, the input connector 31 may be a pogo pin, and the output connector 34 and 53 may be implemented as flat terminals.

In the present embodiment, a configuration in which three types of signals are transmitted to the input connector 31 and the output connector 34 and 53 is described, and a configuration in which only a signal for receiving the DC voltage from the DC power supply 54 is transmitted by another connector may be adopted.

### Functional Configuration of Energization Control Circuit Included in Shopping Cart System

A functional configuration of the energization control circuits 52 and 33 included in the shopping cart system 1 will be described with reference to FIG. 10. FIG. 10 is a block diagram showing an example of a functional configuration of an energization control circuit included in the shopping cart system according to the embodiment.

The energization control circuit 52 included in the power supply device 50 includes a contact determination unit 521 and an energization control unit 522.

The contact determination unit 521 detects whether the socket 41, 42, and 43 and the plugs 46, 47, and 48 are in a contact state, that is, whether the shopping cart 10 is connected to the power supply device 50. The contact determination unit 521 includes, for example, a circuit that conducts when the switch 45 is in an ON state, or a circuit that outputs a predetermined voltage when the switch 45 is in the ON state. A specific circuit configuration is not limited. The contact determination unit 521 may be implemented by a circuit that becomes non-conductive when the switch 45 is in an OFF state.

The energization control unit 522 includes a switching circuit that outputs the DC voltage Ea from the socket 43 to the subsequent stage shopping cart 10 using an output of the contact determination unit 521 as a trigger. The energization control unit 522 is, for example, a load switch. A specific circuit configuration of the switching circuit is not limited, and may be, for example, a switching circuit using a MOSFET, or a mechanical or electrical relay.

When a voltage V (see FIG. 11) measured by the voltage measurement circuit 55 to be described later falls below a predetermined value, the energization control unit 522 stops the supply of the DC voltage Ea, that is, the charging current.

The power supply device 50 further includes the voltage measurement circuit 55. The voltage measurement circuit 55 measures the voltage V (see FIG. 11) across the resistor r incorporated therein.

It is assumed that the resistor R having the same resistance value is connected in parallel to signal lines to which a DC voltage Eb of each shopping cart 10 is supplied. The resistor R is an example of a first resistor in the present disclosure. Therefore, the voltage V across the resistor r has a value that corresponds to the number of shopping carts 10 connected to the power supply device 50. That is, the shopping cart system 1 can predict the number of shopping carts 10 connected to the power supply device 50 based on the value of the voltage V (see FIG. 11). A method for predicting the number of shopping carts 10 connected to the power supply device 50 will be described in detail later (see FIG. 11).

The indicator 56 is connected to the energization control circuit 52. For example, the indicator 56 is turned on when the charging current is supplied, and is turned off when the supply of the charging current is stopped. A manager of the store reduces, for example, the number of shopping carts 10 connected to the power supply device 50 when the indicator 56 is turned off.

The charging unit 30 included in the shopping cart 10 includes the energization control circuit 33. The energization control circuit 33 includes the contact determination unit 521 and an energization control unit 523.

The contact determination unit 521 detects whether another shopping cart 10 is connected to the subsequent stage of the shopping cart 10. The configuration of the contact determination unit 521 is the same as that of the contact determination unit 521 included in the power supply device 50.

The energization control unit 523 includes a switching circuit that outputs the DC voltage Ea received from the power supply device 50 or the previous stage shopping cart 10 from the socket 43 to the subsequent stage shopping cart 10 with the output of the contact determination unit 521 as a trigger. The configuration of the energization control unit 523 is the same as that of the energization control unit 522 provided in the power supply device 50, but does not have the function of stopping the supply of charging current based on the voltage measured by the voltage measurement circuit 55, which is provided in the energization control unit 522.

As described above, in the charging unit 30 included in the shopping cart 10, the resistor R is connected in parallel between the plug 47 to which the DC voltage Eb is supplied and the socket 42. It is assumed that the resistance value of the resistor R is the same in all the charging units 30 (shopping carts 10). The voltage measurement circuit 55 described above predicts the number of shopping carts 10 connected to the power supply device 50 by measuring a voltage drop corresponding to the number of shopping carts 10 connected to the power supply device 50.

### Method for Estimating Number of Connected Shopping Carts

A method for estimating the number of shopping carts 10 connected to the power supply device 50 by the shopping cart system 1 in the embodiment will be described with reference to FIG. 11. FIG. 11 is a diagram showing a method in which the shopping cart system estimates the number of connected shopping carts.

FIG. 11 shows an equivalent circuit of a circuit to which the DC voltage Eb is supplied from the DC power supply 54 of the power supply device 50 (see FIG. 5) when n shopping carts 10 are connected to the power supply device 50.

The DC voltage Eb supplied from the DC power supply 54 is transmitted via the resistor r included in the voltage measurement circuit 55 and the resistor R included in the charging unit 30 of each shopping cart 10 and having the same resistance value. Then, the voltage V corresponding to the number of shopping carts 10 connected is applied across the resistor r.

Since the resistor r is connected in series to the circuit from which the DC voltage Eb is output and the resistor R is connected in parallel to the circuit from which the DC voltage Eb is output, the voltage V across the resistor r when n shopping carts 10 are connected to the power supply device 50 is calculated by Formula (1). For convenience, the resistance value of the resistor r is r, and the resistance value of the resistor R is R.

V=Eb*{nr/(nr+NR)} (1)

For example, when Eb=5 V and r=R=100Ω, V=2.5 V when one shopping cart 10 is connected to the power supply device 50. When two shopping carts 10 are connected to the power supply device 50, V=3.33 V. When three shopping carts 10 are connected to the power supply device 50, V=3.75 V.

As described above, as the number of connected shopping carts 10 increases, the voltage V measured by the voltage measurement circuit 55 increases. Further, when 10 shopping carts 10 are connected to the power supply device 50, V=4.54 V.

When the voltage V across the resistor r exceeds 4.54 V, the energization control circuit 52 (see FIG. 10) determines that more than 10 shopping carts 10 are connected, and stops the supply of charging current.

The voltage measurement circuit 55 may measure the voltage across the resistor R connected in parallel. In this case, as the number of connected shopping carts 10 increases, the voltage across the resistor R connected in parallel decreases, and thus when the voltage across the resistor R connected in parallel falls below a predetermined value, the energization control circuit 52 determines that more than 10 shopping carts 10 are connected and stops the supply of charging current.

In the present embodiment, although it is assumed that the resistors R having the same resistance value are connected to all the shopping carts 10, there are cases in which the shopping carts 10 with different charging currents are connected to the power supply device 50 in a mixed manner. Even in such a case, the shopping cart system 1 according to the present embodiment can estimate the number of connected shopping carts 10. For example, if it is determined that the resistor R having a resistance value of 100Ω is connected to the shopping cart 10 having a charging current of 1 ampere and the resistor R having a resistance value of 200Ω is connected to the shopping cart 10 having a charging current of 2 amperes, the number of connected shopping carts 10 can be estimated even when the connected shopping carts 10 are mixed.

### Effects of Embodiment

As described above, the shopping cart system 1 according to the embodiment includes the plurality of shopping carts 10 including the cart terminals 20 (terminal devices) that register commodities to be purchased, and the power supply device 50 that supplies a charging current to the cart terminals 20. Each of the shopping carts 10 includes the input connector 31 that receives, from the power supply device 50 or the previous stage shopping cart 10, a charging current of the battery 29 of the cart terminal 20 and a DC voltage of the DC power supply 54 included in the power supply device 50 and different from a power supply that supplies the charging current, the resistor R (first resistor) connected in parallel to an input line of the DC voltage, and the output connector 34 (first output connector) that outputs, to the input connector 31 of another shopping cart 10 connected to a subsequent stage of the shopping cart 10, the DC voltage across the resistor R and a part of the charging current received by the input connector 31. The power supply device 50 includes the output connector 53 (second output connector) that outputs, to the input connector 31 of the shopping cart 10, the charging current and the DC voltage via the resistor r (second resistor) connected in series to the output line of the DC power supply 54, the voltage measurement circuit 55 (voltage measurement unit) that measures a voltage across the resistor r, and the energization control unit 522 that stops the charging current when the voltage measured by the voltage measurement circuit 55 exceeds a predetermined value. Therefore, since the power supply device 50 that supplies the charging current to the shopping cart 10 can be used within a range of a rated current, and durability of the power supply device 50 can be ensured.

In the shopping cart system 1 according to the embodiment, the power supply device 50 further includes the indicator 56 (notification unit) that notifies that the energization control unit 522 stops the charging current. Therefore, it is possible to easily notify that the number of connected shopping carts 10 exceeds a specified number.

In the shopping cart system 1 according to the embodiment, the output connector 34 (first output connector) and the output connector 53 (second output connector) further include the contact determination unit 521 that detects whether the output connector 34 and the output connector 53 are in a predetermined contact state with the input connector 31, and the output connector 34 and the output connector 53 perform energization on the input connector 31 under a condition that the contact determination unit 521 determines that the output connector 34 and the output connector 53 are in the predetermined contact state, and prohibit energization of the input connector 31 under a condition that the contact determination unit 521 determines that the output connector 34 and the output connector 53 are not in the predetermined contact state. Therefore, with a simple structure, it is possible to implement a so-called interlock function in which there is no risk of electric shock even when a hand touches an electrical contact.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A shopping cart system, comprising:
a plurality of shopping carts each including a terminal device configured to register a commodity to be purchased; and
a power supply device configured to supply a charging current to the terminal device, wherein
each of the plurality of shopping carts includes
an input connector configured to receive, from the power supply device or a previous stage shopping cart, a charging current of a battery of the terminal device and a DC voltage of a DC power supply included in the power supply device and different from a power supply that supplies the charging current,
a first resistor connected in parallel to an input line of the DC voltage, and
a first output connector configured to output, to an input connector of another shopping cart connected to a subsequent stage of the shopping cart, the DC voltage across the first resistor and a part of the charging current received by the input connector, and
the power supply device includes
a second output connector configured to output, to the input connector of the shopping cart, the charging current and a DC voltage via a second resistor connected in series to an output line of the DC power supply,
a voltage measurement component configured to measure a voltage across the second resistor, and
an energization controller configured to stop the charging current when the voltage measured by the voltage measurement component exceeds a predetermined value.

2. The shopping cart system according to claim 1, wherein
the power supply device further includes a notification component configured to notify that the energization controller stops the charging current.

3. The shopping cart system according to claim 1, wherein
the first output connector and the second output connector further include a contact determination component configured to detect whether the first output connector and the second output connector are in a predetermined contact state with the input connector, and
the first output connector and the second output connector perform energization on the input connector under a condition that the contact determination component determines that the first output connector and the second output connector are in the predetermined contact state, and prohibit energization on the input connector under a condition that the contact determination component determines that the first output connector and the second output connector are not in the predetermined contact state.

4. The shopping cart system according to claim 1, wherein
the batteries of the plurality of shopping carts are connected in parallel when viewed from the power supply device.

5. The shopping cart system according to claim 4, wherein
the batteries are rechargeable secondary batteries that supply a current to various electronic devices included in the shopping carts.

6. The shopping cart system according to claim 4, wherein
the batteries are selected from one or more of a lithium-ion battery, a nickel-cadmium battery, a nickel-hydrogen battery, and a lead storage battery.

7. The shopping cart system according to claim 1, wherein
a number of connectable shopping carts is determined by a current value that can be output by the power supply device, a charging current of the battery, a consumption current of the cart terminal, and consumption currents of various connection devices of the shopping carts.

8. The shopping cart system according to claim 7, wherein
the energization controller stops the supply of the charging current when a number of connected shopping carts is equal to or greater than a predetermined number.

9. The shopping cart system according to claim 1, wherein
the energization controller comprises a switching circuit that outputs DC voltage from a socket to a subsequent stage connected shopping cart using an output of the contact determination component as a trigger.

10. The shopping cart system according to claim 1, wherein
the energization controller comprises a load switch.

11. The shopping cart system according to claim 1, wherein
when a voltage measured by the voltage measurement component falls below a predetermined value, the energization controller stops supplying the charging current.

12. A method for a shopping cart system, comprising:
supplying a charging current to a terminal device in each of a plurality of shopping carts to a power supply device;
receiving, by an input connector, from the power supply device or a previous stage shopping cart, a charging current of a battery of the terminal device and a DC voltage of a DC power supply included in the power supply device and different from a power supply that supplies the charging current;
outputting, by a first output connector, to an input connector of another shopping cart connected to a subsequent stage of the shopping cart, the DC voltage across a first resistor connected in parallel to an input line of the DC voltage and a part of the charging current received by the input connector;
outputting, by a second output connector, to the input connector of the shopping cart, the charging current and a DC voltage via a second resistor connected in series to an output line of the DC power supply;
measuring a voltage across the second resistor using a voltage measurement component; and
stopping, by an energization controller, the charging current when the voltage measured by the voltage measurement component exceeds a predetermined value.

13. The method according to claim 12, further comprising:
the power supply device further includes a notification component configured to notify that the energization controller stops the charging current.

14. The method according to claim 12, further comprising
the first output connector and the second output connector further include a contact determination component configured to detect whether the first output connector and the second output connector are in a predetermined contact state with the input connector, and
the first output connector and the second output connector perform energization on the input connector under a condition that the contact determination component determines that the first output connector and the second output connector are in the predetermined contact state, and prohibit energization on the input connector under a condition that the contact determination component determines that the first output connector and the second output connector are not in the predetermined contact state.

15. The method according to claim 12, wherein
the batteries of the plurality of shopping carts are connected in parallel when viewed from the power supply device.

16. The method according to claim 15, wherein
the batteries are rechargeable secondary batteries that supply a current to various electronic devices included in the shopping carts.

17. The method according to claim 12, further comprising:
determining a number of connectable shopping carts using a current value output by the power supply device, a charging current of the battery, a consumption current of the cart terminal, and consumption currents of various connection devices of the shopping carts.

18. The method according to claim 17, further comprising:
stopping the supply of the charging current when a number of connected shopping carts is equal to or greater than a predetermined number.

19. The method according to claim 12, further comprising:
outputting DC voltage from a socket to a subsequent stage connected shopping cart using an output of the contact determination component as a trigger.

20. The method according to claim 12, further comprising:
when a voltage measured falls below a predetermined value, terminating supplying the charging current.
